(19) United States
(12) Patent Application Publication
(10) Pub. No.: US 2015/0138442 A1
(43) Pub. Date: May 21, 2015

(54) POWER SUPPLY APPARATUS AND DISPLAY APPARATUS USING THE SAME

(71) Applicant: Samsung Electronics Co., Ltd., Suwon-si (KR)

(72) Inventors: Sung-yong JOO, Yongin-si (KR); Jin-hyung LEE, Anyang-si (KR)

(73) Assignee: Samsung Electronics Co., Ltd., Suwon-si (KR)

(21) Appl. No.: 14/326,658

(22) Filed: Jul. 9, 2014

(30) Foreign Application Priority Data
Nov. 20, 2013 (KR) 10-2013-0141261

(51) Int. Cl. H02M 7/06; H04N 5/63

(52) U.S. Cl. CPC H02M 7/06; H04N 5/63
USPC 348/730; 363/89

(57) ABSTRACT

A power supply apparatus and a display apparatus are provided. The power supply apparatus including: a rectifier configured to receive alternating current (AC) power to output a rectified current; a first converter configured to perform a switching operation with respect to the rectified current to output a first output voltage; and a controller configured to control the first converter in order to perform the switching operation so that the first output voltage reaches a first target value in a first period of the input AC current, and not to perform the switching operation in a second period of the input AC power.

### CROSS-REFERENCE TO RELATED APPLICATION

This application claims priority from Korean Patent Application No. 10-2013-0141261, filed on Nov. 20, 2013 in the Korean Intellectual Property Office, the disclosure of which is incorporated herein by reference in its entirety.

### BACKGROUND

1. Technical Field

Apparatuses and methods consistent with the exemplary embodiments relate to a power supply apparatus and a display apparatus using the same. More particularly, the exemplary embodiments relate to a power supply apparatus to supply power to an electronic device and a display apparatus using the same.

2. Description of the Related Art

An electronic device including a display apparatus such as a TV is supplied with power from an internal or external power supply apparatus in order to operate. FIG. 1 is a circuit diagram of a power supply apparatus according to the related art. Details of the power supply apparatus to be mentioned herein may not be generally known. The power supply apparatus 1 shown in FIG. 1 includes a rectifier 12, an inductor 13, a diode 14, a switch 15, a capacitor 16, resistors 17 and 18, and a controller 19. The rectifier 12 receives alternating current (AC) power 11 (see Vin and Iin) to output a rectified electric current Ia. The switch 15 switches the electric current Ia flowing through the inductor 13 so that an electric current Id flows through the diode 14 or an electric current Is flows through the switch 15. The electronic device operates using an output voltage Vo from the capacitor 16. The controller 19 controls the switch 15 so that the output voltage Vo reaches a preset target value based on a voltage Vd across a resistor 18.

The power supply apparatus 1 may perform the switching operation in diverse modes. For instance, the power supply apparatus 1 may perform the switching operation either in a discontinuous conduction mode or in a continuous conduction mode. FIG. 2 is a waveform illustrating an electric current 21 (see Ia of FIG. 1) flowing through the inductor 13, and a peak 22 and an average 23 of the electric current 21 in the discontinuous conduction mode, and FIG. 3 is a waveform illustrating an electric current 31 flowing through the inductor 13, and a peak 32 and an average 33 of the electric current 31 in the continuous conduction mode. Since the power supply apparatus 1 supplies power by performing the switching operation, efficiency in power conversion, that is, a power factor, may be enhanced and power may be stably supplied.

However, the switching operation of the power supply apparatus 1 may cause an undesired result. For example, the power supply apparatus 1 may bring unnecessary power consumption in switching of the switch 15. FIG. 4 is a waveform illustrating a voltage 41 (see Vs of FIG. 1) and an electric current 42 (see Is of FIG. 1) of the switch 15 in the discontinuous mode, and FIG. 5 is a waveform illustrating a voltage 51 and an electric current 52 of the switch 15 in the continuous mode. As shown in FIGS. 4 and 5, an unnecessary electric current is generated at a switching point 43 and 53 of the switch 15, causing power loss. In particular, unnecessary power loss due to the switching operation of the power supply apparatus 1 may occur substantially around an edge of the input current (see Iin of FIG. 1). FIG. 6 illustrates a waveform 61 of the input AC power 11. As shown in FIG. 6, unnecessary power loss due to the switching operation of the power supply apparatus 1 may frequently occur in a period 62 (hereinafter, also referred to as a “reactive power period”) corresponding to an edge of the input AC power 11.

### SUMMARY

An aspect of one or more exemplary embodiments is to provide a power supply apparatus which is capable of minimizing unnecessary power loss due to a switching operation while improving a power factor and maintaining stable power supply, and a display apparatus using the same.

The foregoing and/or other aspects may be achieved by providing a power supply apparatus including: a rectifier configured to receive alternating current (AC) power to output a rectified current; a first converter to perform a switching operation with respect to the rectified current in order to output a first output voltage; and a controller configured to control the first converter to perform the switching operation so that the first output voltage reaches a first target value in a first period of the input AC current, and not to perform the switching operation in a second period of the input AC power.

The second period may include a zero crossing point of the input AC power.

The controller may be configured to determine the zero crossing point based on a frequency of the input AC power.

The controller may be configured to determine a third zero crossing point of the second period based on a period between a first zero crossing point and a second zero crossing point of the input AC power.

A width of the second period may be determined so that a harmonic component of the power supply apparatus is less than a predetermined limit.

The power supply apparatus may further include a second converter configured to receive the first output voltage output from the first converter in order to output a second output voltage having a second target value smaller than the first target value.

The foregoing and/or other aspects may also be achieved by providing a display apparatus including: a display configured to display an image; and a power supply configured to supply power to the display, wherein the power supply includes a rectifier configured to receive alternating current (AC) power to output a rectified current; a first converter configured to perform a switching operation with respect to the rectified current to output a first output voltage; and a controller configured to control the first converter to perform the switching operation so that the first output voltage reaches a first target value in a first period of the input AC current, and not to perform the switching operation in a second period of the input AC power.

The second period may include a zero crossing point of the input AC power.

The controller may determine the zero crossing point based on a frequency of the input AC power.

The controller may determine a third zero crossing point of the second period based on a period between a first zero crossing point and a second zero crossing point of the input AC power.

A width of the second period may be determined so that a harmonic component of the power supply apparatus is less than a predetermined limit.

An aspect of an exemplary embodiment may provide a power supply apparatus including: a converter configured to perform a switching operation with respect to a rectified current in order to output a first output voltage; and a controller configured to control the converter to perform the switching operation so that the first output voltage reaches a first target value in a first period of an input AC current.

The power supply apparatus may further include a rectifier configured to receive alternating current (AC) power in order to output the rectified current.

The controller may be configured to perform the switching operation during a second period of input AC power.

The second period may include a zero crossing point of the input AC power.

The controller may be configured to determine the zero crossing point based on a frequency of the input AC power.

The controller may be configured to determine a third zero crossing point of the second period based on a period between a first zero crossing point and a second zero crossing point of the input AC power.

A width of the second period may be determined so that a harmonic component of the power supply apparatus is less than a predetermined limit.

The display apparatus may further include a second converter configured to receive the first output voltage which is output from the first converter to output a second output voltage having a second target value smaller than the first target value.

As described above, one or more exemplary embodiments may minimize unnecessary power loss due to a switching operation while improving a power factor and maintaining stable power supply.

### BRIEF DESCRIPTION OF THE DRAWINGS

The above and/or other aspects will become apparent and more readily appreciated from the following description of the exemplary embodiments, taken in conjunction with the accompanying drawings, in which:

FIG. 1 is a circuit diagram of a power supply apparatus according to a related art.

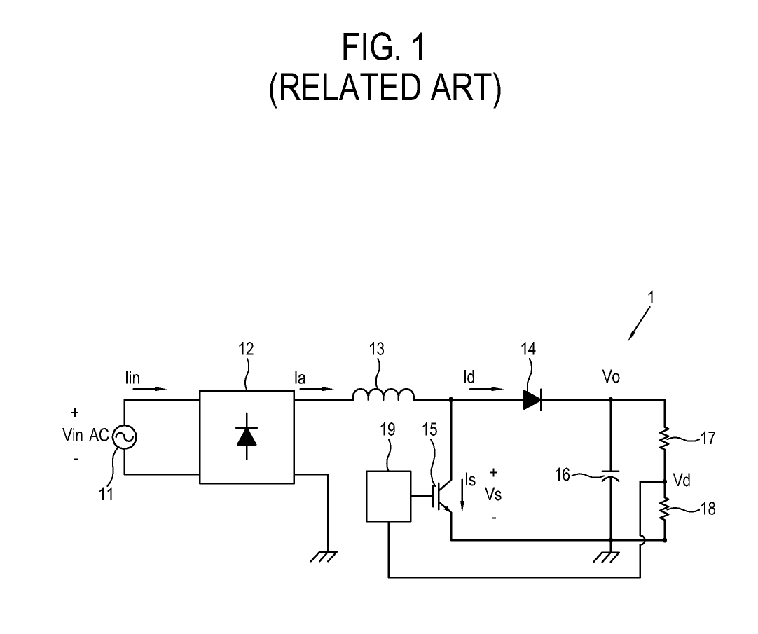

FIGS. 2 and 3 respectively illustrate waveforms of an electric current flowing through an inductor in a discontinuous conduction mode and a continuous conduction mode of the power supply apparatus according to a related art.

FIGS. 4 and 5 illustrate waveforms of a voltage and an electric current in the discontinuous conduction mode and the continuous conduction mode of the power supply apparatus, respectively according to a related art.

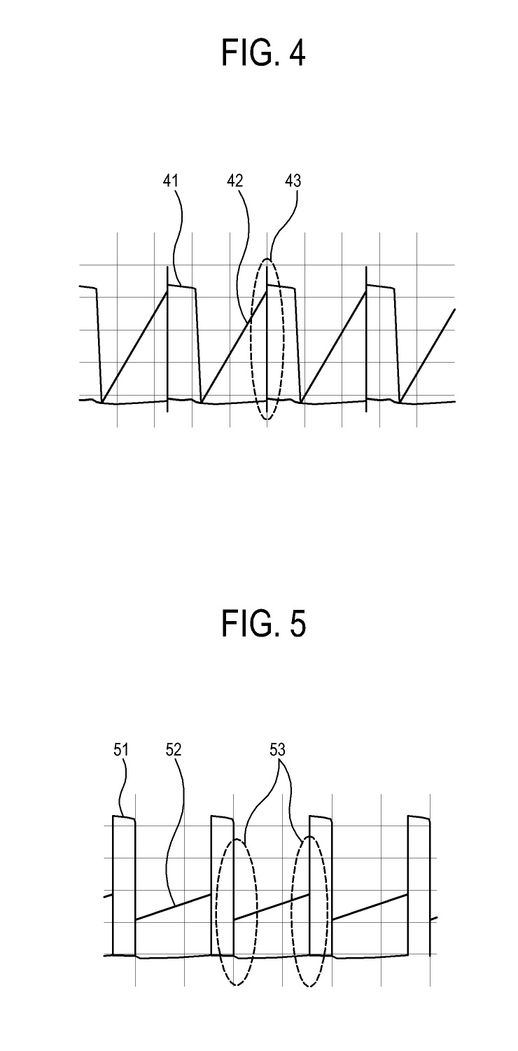

FIG. 6 illustrates a waveform of alternating current (AC) power of the power supply apparatus according to a related art.

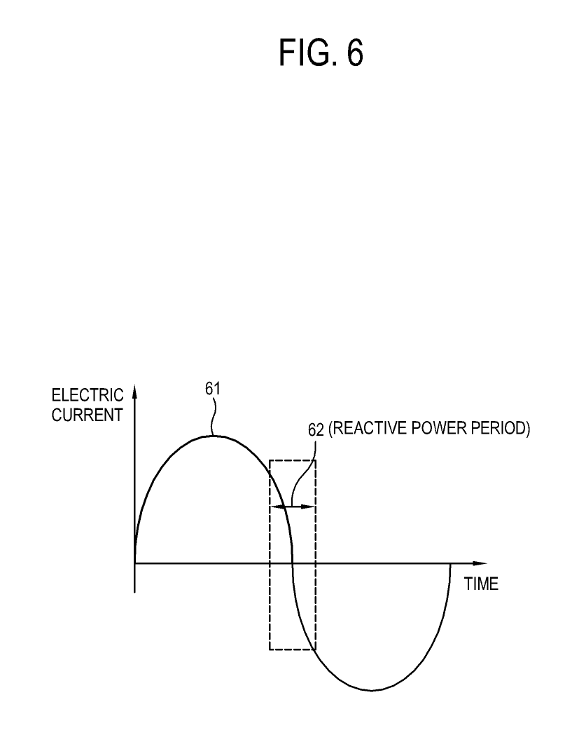

FIG. 7 is a circuit diagram of a power supply apparatus according to an exemplary embodiment.

FIG. 8 illustrates a waveform of AC power of the power supply apparatus and a first period and a second period regarding a switching operation according to an exemplary embodiment.

FIG. 9 is a block diagram which illustrates a power supply apparatus according to another exemplary embodiment.

FIG. 10 is a block diagram which illustrates a display apparatus according to an exemplary embodiment.

### DETAILED DESCRIPTION OF THE EXEMPLARY EMBODIMENTS

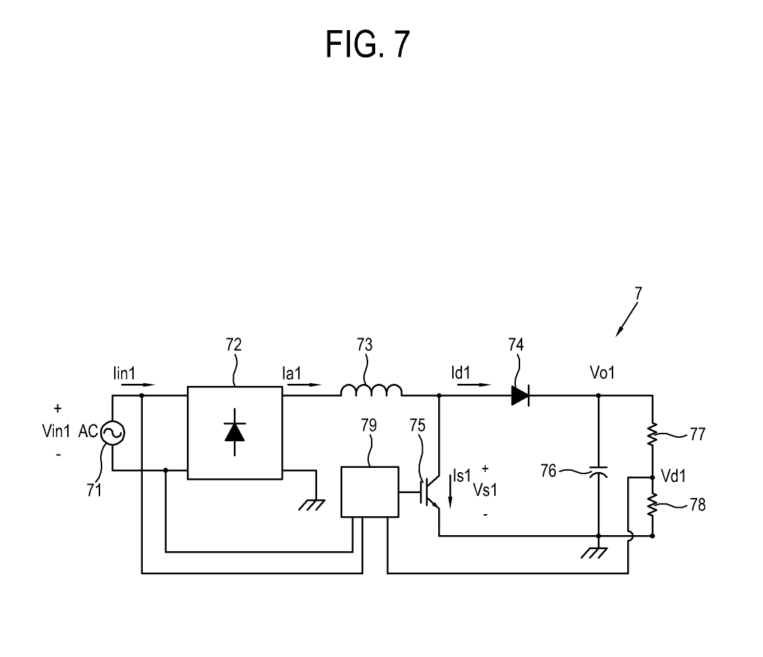

Below, exemplary embodiments will be described in detail with reference to the accompanying drawings. FIG. 7 is a circuit diagram of a power supply apparatus according to an exemplary embodiment. As shown in FIG. 7, the power supply apparatus 7 supplies power to an electronic device, including a display apparatus such as a TV. The power supply apparatus 7 may be provided as a separate device or may be disposed in the electronic device. The power supply apparatus 7 of FIG. 7 includes a rectifier 72, an inductor 73, a diode 74, a switch 75, a capacitor 76, resistors 77 and 78 and a controller 79. The rectifier 72 receives alternating current (AC) power 71 to output a rectified electric current Ia1. The AC power 71 may be general-purpose AC power having a frequency of about 50 to 60 Hz. Vin1 and Iin1 respectively represent a voltage and a current of the AC power 71.

The switch 75 switches the electric current Ia1 flowing through the inductor 73 so that an electric current Id1 flows through the diode 74 or an electric current Is1 flows through the switch 75. The switch 75 may be a Metal-Oxide-Semiconductor Field-Effect Transistor (MOSFET). The switch 75 has a turn-on state and a turn-off state. In response to the switch 75 being in the turn-on state, the electric current Is1 flows mostly through the switch 75. The electric current Id1 flowing through the diode 74 is substantially 0, and a level of the electric current Is1 flowing through the switch 75 is nearly the same as that of the electric current Ia1 flowing through the inductor 73. Meanwhile, in response to the switch 75 being in the turn-off state, the electric current Id1 mostly flows through the diode 74. The electric current Is1 flowing through the switch 75 is substantially 0 and a level of the electric current Id1 flowing through the diode 74 is nearly the same as that of the electric current Ia1 flowing through the inductor 73. In response to the switch 75 being in the turn-on state, the levels of the electric current Ia1 flowing through the inductor 73 and the electric current Is1 flowing through the switch 75 gradually increase. In response to the switch 75 being in the turn-off state, the levels of the electric current Ia1 flowing through the inductor 73 and the electric current Id1 flowing through the diode 74 gradually decrease.

An output voltage Vo1 is generated in the capacitor 76 by a switching operation of the switch 75. The electronic device operates using the output voltage Vo1 from the capacitor 76. The controller 79 determines a level of the output voltage Vo1 based on a voltage Vd1 across the resistor 78 and controls the switch 75 so that the output voltage Vo1 reaches a preset target value. The controller 79 may control the switch 75 by pulse-width modulation (PWM). In response to the level of the output voltage Vo1 being lower than the target value, the controller 79 increases a duty ratio which corresponds to the turn-on state of the switch 75. In response to the level of the output voltage Vo1 being greater than the target value, the controller 79 decreases the duty ratio which corresponds to the turn-on state of the switch 75. The level of the output voltage Vo1 may be determined in advance corresponding to an electronic device using the output voltage Vo1. For example, in response to the electronic device being a mass device such as a large screen TV, the output voltage Vo1 may be about 300 to 400 [V]. The inductor 73, the diode 74, the switch 75 and the capacitor 76 comprise a first converter in an exemplary embodiment.

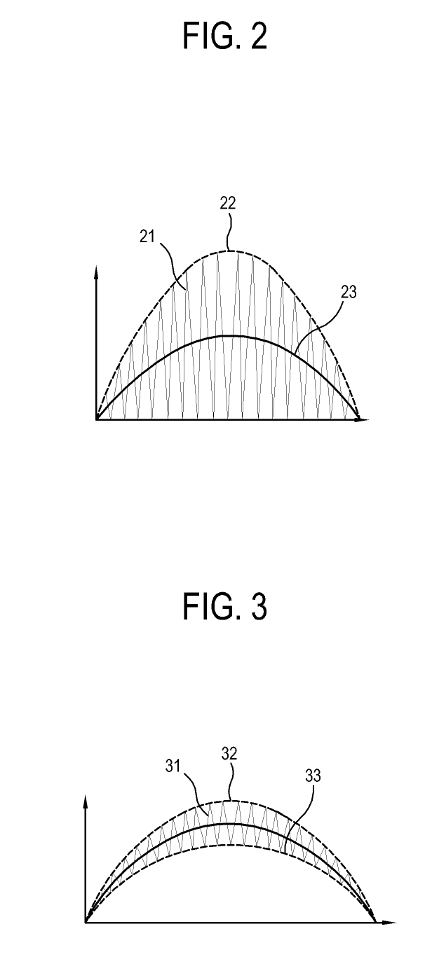

The controller 79 of the power supply apparatus 7 may control the switch 75 to conduct the switching operation in diverse modes. For example, the controller 79 may control the switch 75 to perform the switching operation basically either in the discontinuous conduction mode (see FIG. 2) or in the continuous conduction mode (see FIG. 3). For example, in the discontinuous conduction mode, timing at which the switch 75 is turned on may be constant. In this case, a peak 21 of the electric current Ia1 flowing through the inductor 73 may be controlled to follow a phase of an input voltage Vin1. In the continuous conduction mode, timing at which the switch 75 is turned on may be varied. In this case, the controller 79 may detect the input voltage Vin1 and an input electric current Iin1 to control a path of the electric current Ia1 flowing through the inductor 73 to be approximately an average thereof 33 (see FIG. 3).

As such, the power supply apparatus 7 basically performs the switching operation to supply power, thereby enhancing efficiency in conversion of power, that is, a power factor, and stably supplying power.

Furthermore, the power supply apparatus 7 does not perform the switching operation in a reactive power period 62 in which unnecessary power loss occurs due to the switching operation, thereby minimizing unnecessary power loss due to the switching operation to maximize the power factor. That is, the controller 79 controls the switch 75 to perform the switching operation in a first period of the AC power 71 so that the output voltage Vo1 reaches the target value, and controls the switch 75 not to perform the switching operation in a second period of the AC power 71.

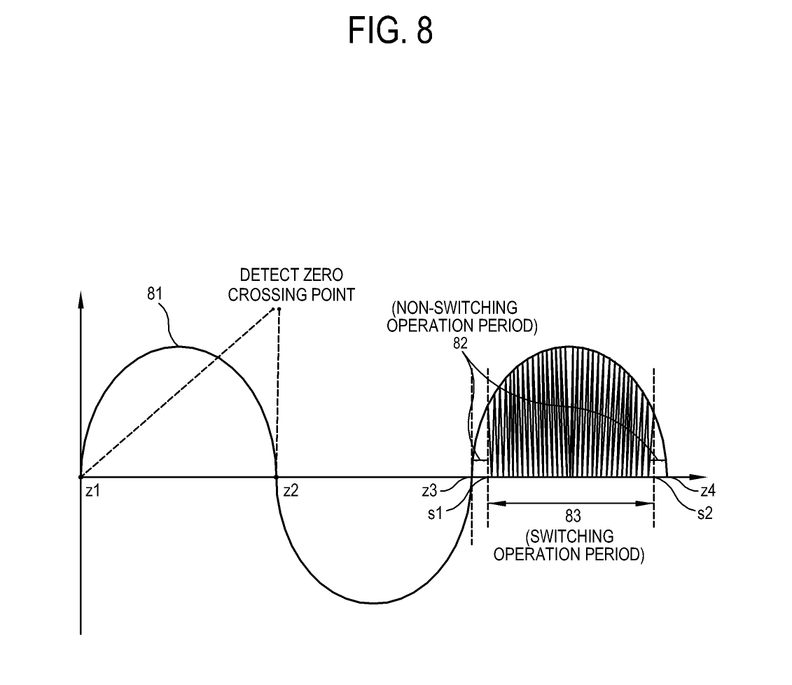

FIG. 8 illustrates a waveform 81 of the AC power 71 and a first period and a second period regarding the switching operation according to an exemplary embodiment. As shown in FIG. 8, the controller 79 controls the switch 75 to perform the switching operation in the first period 83 of the AC power 71 so that the output voltage Vo1 reaches the target value. The controller 79 controls the switch 75 so as to not perform the switching operation in the second period 82 of the AC power 71. Accordingly, the power factor is improved and stable power supply is maintained in the first period 83 of the AC power 71 while unnecessary power loss due to the switching operation is minimized in the second period 82 of the AC power 71.

As shown in FIG. 8, the second period 82 in which the switching operation is skipped may include zero crossing points z1 to z4 of the input AC power 71. The controller 79 may determine the zero crossing points z1 to z4 based on a frequency of the input AC power 71. For example, in response to the general-purpose AC power 71 having a frequency of 50 Hz, the controller 79 may determine the zero crossing points z1 to z4 on a cycle of 10 ms. When the AC power 71 has a frequency of 60 Hz, the controller 79 may determine the zero crossing points z1 to z4 on a cycle of about 8.3 ms.

The controller 79 may determine a third zero crossing point z3 of the second period 82 based on a period between a first crossing point z1 and a second zero crossing point z2 of the input AC power 71. For example, as shown in FIGS. 7 and 8, the controller 79 monitors the input AC power 71 to detect the first zero crossing point z1 and the second zero crossing point z2 and measures the period between the first zero crossing point z1 and the second zero crossing point z2. Subsequently, the controller 79 starts counting from the second zero crossing point z2 and determines the time after the period between the first zero crossing point z1 and the second zero crossing point z2 since the counting starts as the third zero crossing point z3. A fourth zero crossing point z4 may be determined in the same manner as the third zero crossing point z3.

The controller 79 may determine widths from z3 to s1 and from s2 to z4 of the second period 82 to have a predetermined range. For example, the widths from z3 to s1 and from s2 to z4 of the second period 82 may be determined such that a harmonic component of the power supply apparatus 7 is less than a predetermined limit. The harmonic component of the power supply apparatus 7 may be determined in advance to correspond to an electronic device to which the power supply apparatus 7 supplies power. The widths from z3 to s1 and from s2 to z4 of the second period 82 may be determined such that a total harmonic distortion ranges from 5% to 8% with respect to an electronic device to which the power supply apparatus 7 supplies power. The widths from z3 to s1 and from s2 to z4 of the second period 82 may be determined in terms of an angle in the range of 15° to 20° from among a total angle of 360°.

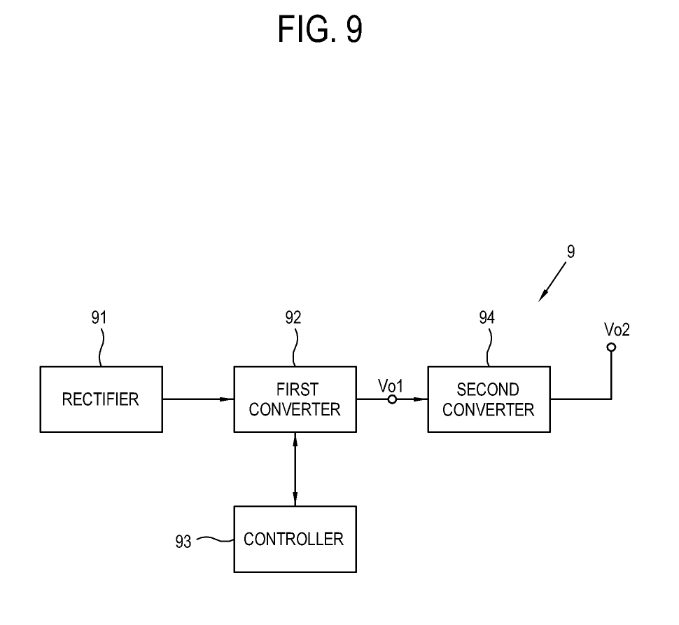

FIG. 9 is a block diagram illustrating a power supply apparatus according to another exemplary embodiment. As shown in FIG. 9, the power supply apparatus 9 may include a rectifier 91, a first converter 92, a second converter 94 and a controller 93. The rectifier 91, the first converter 92 and the controller 93 shown in FIG. 9 are equivalent or similar in configuration to the rectifier 82, the first converter and the controller 79 illustrated in FIGS. 7 and 8. The second converter 94 receives a first output voltage Vo1 output from the first converter 92 and converts the first output voltage Vo1 into a second output voltage Vo2. The electronic device may operate using the second output voltage Vo2. The second output voltage Vo2 may be lower than the first output voltage Vo1. For instance, the first output voltage Vo1 may be about 300 to 400 [V], while the second output voltage Vo2 may be about 5 to 24 [V]. That is, the power supply apparatus 9 may improve a power factor and supply power in a more stable manner than using the first converter 92, and may supply a proper level of power to each component of the electronic device using the second converter 94.

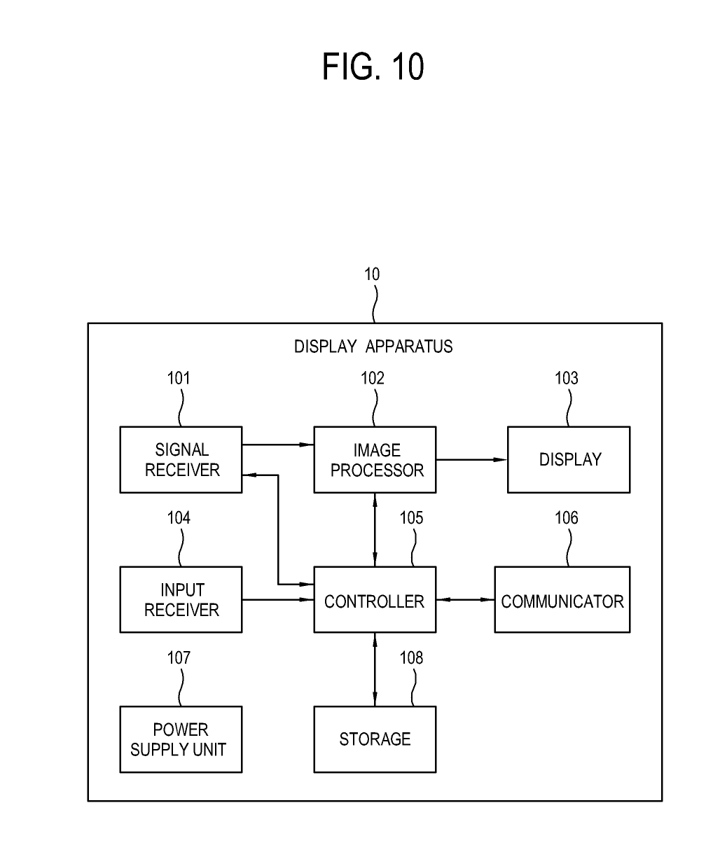

FIG. 10 is a block diagram which illustrates a display apparatus according to an exemplary embodiment. The display apparatus 10 shown in FIG. 10 is an example of the electronic device. The display apparatus 10 may include a signal receiver 101, an image processor 102, a display 103, an input receiver 104, a controller 105, a communicator 106, a power supply 107 and a storage 108. A configuration of the display apparatus 10 shown in FIG. 10 is provided for illustrative purposes only and may be changed as necessary. That is, although not shown, at least one of the components of the display apparatus 10 shown in FIG. 10 may be excluded or a new component or components may be added.

The signal receiver 101 receives an image signal. The signal receiver 101 may include a tuner to receive an image signal such as a broadcast signal. The tuner may tune and receive an image signal of any one channel selected from a plurality of channels according to control by the controller 105. The channel may be selected by a user. The input receiver 104 may receive a user input. The input receiver 104 receives a user input with respect to selection of a channel and transmits the input to the controller 105. The input receiver 104 may include a manipulation panel to receive a user input or a remote control signal receiver to receive a remote control signal including a user input, from a remote controller. Alternatively, the input receive 104 may include an audio receiver such as a microphone to receive a voice as a user input or include an image receiver such as a camera to receive an image obtained by photographing a motion or gesture, as a user input.

In another exemplary embodiment, the signal receiver 101 may receive an image signal from an imaging device such as a set-top box, a DVD and a PC, receive an image signal from a peripheral device such as a smartphone, or receive an image signal from a server through a network such as the Internet.

The image processor 102 processes a received image signal to display an image on the display 103. The image processor 102 may conduct image processing, for example, modulation, demodulation, multiplexing, demultiplexing, analog-to-digital conversion, digital-to-analog conversion, decoding, encoding, image enhancement and scaling, on the received image signal.

The display 103 displays an image based on the image signal processed by the image processor 102. The display 103 may display an image in various modes such as an LCD, a PDP and an OLED.

The controller 105 controls the signal receiver 101 and the image processor 102 to display an image based on an input image signal based on a user input made through the input receiver 104. The controller 105 may include a control program which performs such control, a nonvolatile memory and a volatile memory to store all or part of the control program, and a microprocessor to execute the control program.

The communicator 106 communicates with an external device through a wire-based or wireless network to exchange information and/or data needed for an operation of the display apparatus 10 with the external device. The storage 108 is configured as a nonvolatile memory such as a flash memory and a hard disk and stores a program, information and data needed for the operation of the display apparatus 10.

The power supply 107 supplies power so that the signal receiver 101, the image processor 102, the display 103, the input receiver 104, the controller 105, the communicator 106, the power supply 107 and the storage 108 operate. The power supply 107 is equivalent or similar in configuration to the power supply apparatuses 7 and 9 illustrated in FIGS. 7 to 9.

Although a few exemplary embodiments have been shown and described, it will be appreciated by those skilled in the art that changes may be made in these exemplary embodiments without departing from the principles and spirit of the invention, the scope of which is defined in the appended claims and their equivalents.

What is claimed is:

1. A power supply apparatus comprising:
a rectifier configured to receive alternating current (AC) power in order to output a rectified current;
a first converter configured to perform a switching operation with respect to the rectified current to output a first output voltage; and
a controller configured to control the first converter to perform the switching operation so that the first output voltage reaches a first target value in a first period of the input AC current, and not to perform the switching operation during a second period of input AC power.

2. The power supply apparatus of claim 1, wherein the second period comprises a zero crossing point of the input AC power.

3. The power supply apparatus of claim 2, wherein the controller is configured to determine the zero crossing point based on a frequency of the input AC power.

4. The power supply apparatus of claim 2, wherein the controller is configured to determine a third zero crossing point of the second period based on a period between a first zero crossing point and a second zero crossing point of the input AC power.

5. The power supply apparatus of claim 1, wherein a width of the second period is determined so that a harmonic component of the power supply apparatus is less than a predetermined limit.

6. The power supply apparatus of claim 1, further comprising a second converter configured to receive the first output voltage output from the first converter to output a second output voltage having a second target value smaller than a first target value of the first output voltage.

7. A display apparatus comprising:
a display configured to display an image; and
a power supply configured to supply power to the display,
wherein the power supply comprises a rectifier configured to receive alternating current (AC) power in order to output a rectified current;
a first converter configured to perform a switching operation with respect to the rectified current in order to output a first output voltage; and
a controller configured to control the first converter to perform the switching operation so that the first output voltage reaches a first target value in a first period of the input AC current, and not to perform the switching operation in a second period of the input AC power.

8. The display apparatus of claim 7, wherein the second period comprises a zero crossing point of the input AC power.

9. The display apparatus of claim 8, wherein the controller is configured to determine the zero crossing point based on a frequency of the input AC power.

10. The display apparatus of claim 8, wherein the controller is configured to determine a third zero crossing point of the second period based on a period between a first zero crossing point and a second zero crossing point of the input AC power.

11. The display apparatus of claim 7, wherein a width of the second period is determined so that a harmonic component of the power supply apparatus is less than a predetermined limit.

12. The display apparatus of claim 7, further comprising a second converter to receive the first output voltage output from the first converter to output a second output voltage having a second target value smaller than a first target value of the first output voltage.

13. A power supply apparatus comprising:
a converter configured to perform a switching operation with respect to a rectified current in order to output a first output voltage; and
a controller configured to control the converter to perform the switching operation so that the first output voltage reaches a first target value in a first period of an input AC current.

14. The power supply apparatus of claim 13 further comprising a rectifier configured to receive alternating current (AC) power in order to output the rectified current.

15. The power supply of claim 14, wherein the controller is configured to perform the switching operation during a second period of input AC power.

16. The power supply apparatus of claim 15, wherein the second period comprises a zero crossing point of the input AC power.

17. The power supply apparatus of claim 16, wherein the controller is configured to determine the zero crossing point based on a frequency of the input AC power.

18. The power supply apparatus of claim 17, wherein the controller is configured to determine a third zero crossing point of the second period based on a period between a first zero crossing point and a second zero crossing point of the input AC power.
